(19) United States
(12) Patent Application Publication
(10) Pub. No.: US 2025/0023075 A1
(43) Pub. Date: Jan. 16, 2025

(54) HYDROGEN VENTING CATALYTIC CONVERTER AND ENERGY RECOVERY

(71) Applicant: Joby Aero. Inc., Santa Cruz, CA (US)

(72) Inventors: Michael Patrick Tucker, Palo Alto, CA (US); Jeffrey Allen Lotterman, Los Angeles, CA (US)

(21) Appl. No.: 18/771,607

(22) Filed: Jul. 12, 2024

Related U.S. Application Data
(60) Provisional application No. 63/513,184, filed on Jul. 12, 2023.

(51) Int. Cl. H01M 8/0662; H01M 8/04111; H01M 8/0606

(52) U.S. Cl. CPC H01M 8/0662; H01M 8/04111; H01M 8/0606; H01M 2250/20

(57) ABSTRACT

A system for use with a fuel cell stack supplied by a tank of hydrogen includes a combustor coupled to the fuel cell exhaust line to receive and combust residual hydrogen gas in the exhaust, a turbine coupled to the combustor to receive combusted exhaust from the combustor; and a mechanical device coupled to the turbine to extract work from rotation of the turbine. The combustor may further be coupled to receive and combust hydrogen in fuel cell circulation-loop purge gas, and the combustor may further combust hydrogen received from the fuel tank via a fuel tank purge line or on demand. Supplementary oxygen may be supplied to the combustor based on an oxygen level detected by the oxygen sensor in the combustor exhaust line.

### RELATED APPLICATION DATA

This application claims the benefit of U.S. Provisional Patent Application No. 63/513,184 filed on Jul. 12, 2023, the contents of which are incorporated herein by reference as if explicitly set forth.

### TECHNICAL FIELD

This disclosure relates generally to the field of fuel cells fueled by hydrogen, including for example for use in electrically-powered or hybrid-powered aircraft.

### BACKGROUND

Fuel cell vehicles are powered by compressed hydrogen gas that is fed into an onboard fuel cell “stack,” which transforms the hydrogen's chemical energy into electrical energy. This electricity is then available to power the vehicle and its onboard systems.

Hydrogen supplied to a fuel cell comes into contact with a catalyst that promotes the separation of hydrogen atoms into an electron and proton. The electrons are gathered by a conductive current collector, which is connected to the vehicle's high-voltage circuitry, feeding an onboard battery and/or electric motors that propel the vehicle. The byproduct of the reaction occurring in the fuel cell stack is water vapor, which is emitted through an exhaust.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a plan view of an aircraft according to some examples.

FIG. 2 is a schematic view of an aircraft energy system according to some examples.

FIG. 3 is a schematic diagram illustrating a hydrogen and air supply system for use in supplying the fuel cell stack of the aircraft of FIG. 1, according to some examples.

FIG. 4 is a schematic diagram illustrating a hydrogen and air supply system for use in the aircraft of FIG. 1, according to some examples.

FIG. 5 is a schematic diagram illustrating a hydrogen and air supply system for use in the aircraft of FIG. 1, according to some examples.

FIG. 6 is a schematic diagram illustrating the connections to the combustor of the hydrogen and air supply system of FIG. 3 in more detail.

FIG. 7 is a flowchart illustrating operation of the energy supply system of FIG. 2, FIG. 3 and/or FIG. 6, according to some examples.

FIG. 8 a flowchart illustrating operation of the energy supply system of FIG. 2, FIG. 3 and/or FIG. 6, according to some examples.

FIG. 9 illustrates a diagrammatic representation of a machine in the form of a computer system within which a set of instructions may be executed for causing the machine to perform any one or more of the methodologies discussed herein, according to some examples.

### DETAILED DESCRIPTION

The following description of examples of the invention is not intended to limit the invention to these examples, but rather to enable any person skilled in the art to make and use this invention.

At times, a hydrogen fuel cell may be required to release excess or residual hydrogen. For example, the fuel cell exhaust may contain residual hydrogen that has not been used by the fuel cell. Similarly, required purges of a hydrogen circulation loop to eliminate excess nitrogen or water, may include excess hydrogen. Finally, hydrogen that evaporates in a liquid hydrogen tank may need to be purged to maintain the pressure in the tank at an appropriate level. As disclosed herein, excess or residual hydrogen gas is combusted in a combustor to convert such hydrogen gas to water, and also to generate additional work that may, in some examples, be used to help compression of air for used in the fuel cell, but may also be used for other purposes.

The following description of examples of the invention is not intended to limit the invention to these examples, but rather to enable any person skilled in the art to make and use this invention.

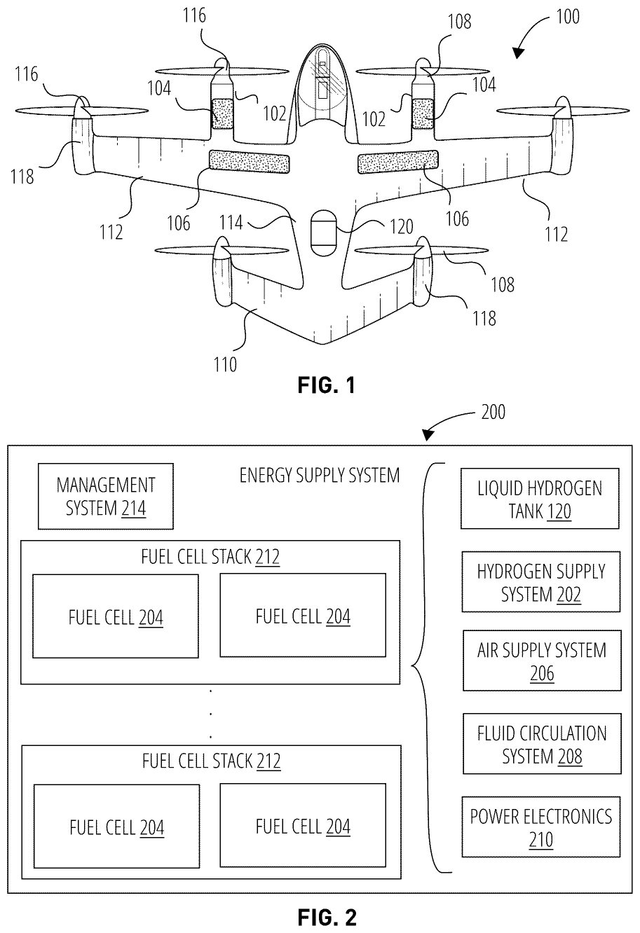

FIG. 1 is a plan view of an aircraft 100 according to some examples. The aircraft 100 includes a fuselage 114, two wings 112, an empennage 110 and propulsion systems 108 embodied as tiltable rotor assemblies 116 located in nacelles 118, 102. The aircraft 100 includes one or more fuel cell stacks, in some examples embodied as nacelle fuel cell stacks 104 and wing fuel cell stacks 106, which are supplied with hydrogen from a liquid hydrogen tank 120. The aircraft 100 will typically include associated equipment such as an electronic infrastructure, control surfaces, a cooling system, landing gear and so forth.

The wings 112 function to generate lift to support the aircraft 100 during forward flight. The wings 112 can additionally or alternately function to structurally support the fuel cell stacks 104, 106 and/or propulsion systems 108 under the influence of various structural stresses (e.g., acrodynamic forces, gravitational forces, propulsive forces, external point loads, distributed loads, and/or body forces, and so forth).

FIG. 2 is a schematic view of an aircraft energy supply system 200 according to some examples. As shown, the energy supply system 200 includes one or more fuel cell stacks 212. Each fuel cell stack 212 includes one or more fuel cells 204.

Typically associated with a fuel cell stack 212 are a source of hydrogen such as a liquid hydrogen tank 120, a hydrogen supply system 202 for supplying hydrogen and air to the fuel cell stack 212 and for dealing with byproducts, an air supply system 206 for supplying air to the fuel cell stack 212 and for dealing with fuel cell exhaust, a fluid circulation system 208 for transferring heat, and power electronics 210 for regulating delivery of electrical power from the fuel cell stacks 212 during operation. The electronic infrastructure also includes an energy supply management system 214, for monitoring and controlling operation of the energy supply system 200 and to provide integration of the energy supply system 200 with the electronic infrastructure of the aircraft 100.

The fuel cell stacks 212 function to convert chemical energy into electrical energy for supply to the propulsion systems 108. Fuel cell stacks 212 can be arranged and/or distributed about the aircraft in any suitable manner. Fuel cell stacks can be arranged within wings (e.g., inside of an airfoil cavity), inside nacelles, and/or in any other suitable location on the aircraft.

The fluid circulation system 208 functions to transfer heat from or to various components of the aircraft 100, for example by circulating a working fluid within a fuel cell stack 212 to remove heat generated during operation, to provide heat for evaporation of liquid hydrogen from the liquid hydrogen tank 120, or to remove heat from other heat-generating components within the aircraft 100.

It is to be understood that the powertrain can in other examples analogously be implemented with alternative types of powertrain architectures, such as a fuel-cell hybrid powertrain architecture with electric batteries as an additional or alternative source or power, or for storage of electrical energy generated by the fuel cell.

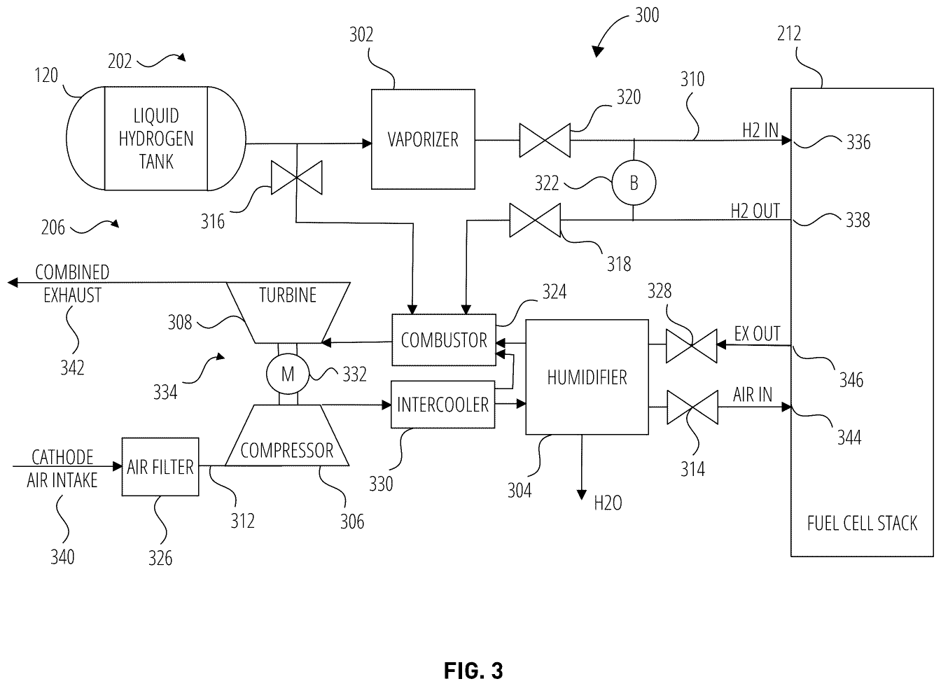

FIG. 3 is a schematic diagram illustrating a hydrogen and air supply system 300 for use in supplying the fuel cell stack 212 of the aircraft 100, according to some examples. The hydrogen and air supply system 300 includes an interconnected hydrogen supply system 202 and an air supply system 206. The hydrogen supply system 202 comprising a liquid hydrogen tank 120, a vaporizer 302, a blower 322 and associated valves and supply lines. The air supply system 206 includes an air filter 326 that receives air from a cathode air intake 340, a combined turbine and compressor 334, an intercooler 330, a humidifier 304, a combustor 324, and associated valves and supply lines.

The liquid hydrogen tank 120, as its name suggests, stores liquid hydrogen for use in the fuel cell stack 212. The liquid hydrogen tank 120 is connected to, and supplies liquid hydrogen to the vaporizer 302. The vaporizer 302 includes a pump that pressurizes the liquid hydrogen and a heat exchanger that evaporates and expands the liquid hydrogen to approximately the temperature required by the fuel cell stack 212, and to a pressure above that required by the fuel cell stack 212. Hydrogen gas leaving the vaporizer 302 is provided to the hydrogen inlet 336 of the fuel cell stack 212 via supply line 310 via a valve 320. The valve 320 serves to regulate the pressure of the hydrogen gas supplied to the fuel cell stack 212 to a nominal fuel cell supply pressure.

Also provided in the supply line 310 from the liquid hydrogen tank 120 to the vaporizer 302 is a purge valve 316, which serves to release pressure generated in the liquid hydrogen tank 120 due to evaporation of the hydrogen in the liquid hydrogen tank 120. Excess hydrogen purged by the purge valve 316 from the liquid hydrogen tank 120 is routed to the combustor 324, where it is combined with oxygen to create water and generate heat, which results in a pressure increase of the air leaving the combustor 324. The air leaving the combustor 324 is used to drive the turbine 308 of the turbine and compressor 334 as will be described in more detail below.

An excessive supply of hydrogen to the fuel cell stack 212 is generally required for high power vehicular applications. The excess hydrogen that is not consumed by the fuel cell stack 212, leaving via the hydrogen outlet 338 of the fuel cell stack 212, is thus recycled back to the hydrogen inlet 336 via a blower 322. Excess hydrogen leaving the fuel cell stack 212 typically includes some water vapor and an accumulation of nitrogen. Hydrogen leaving the fuel cell stack 212 can periodically be purged through a purge valve 318 to alleviate this accumulation. As before, excess hydrogen purged by the purge valve 318 from the fuel cell stack 212 is routed to the combustor 324.

The turbine and compressor 334 includes a compressor 306, a turbine 308 and a motor 332. The compressor 306 compresses air received at a cathode air intake 340, after it has been filtered by an air filter 326, to the pressure required by the fuel cell stack 212. Inlet air, which is generally dry at altitude, is then humidified by the humidifier 304. In some examples, the humidifier 304 includes a membrane that allows water vapor from the fuel cell exhaust to pass through it to the inlet air. In certain circumstance, the humidifier 304 may also operate to dehumidify the inlet air. The humidified inlet air then enters the fuel cell stack 212 at the air inlet 344 after passing through a valve 314. The compressor 306 is driven by the motor 332, which is mechanically assisted by the turbine 308.

Exhaust air, which includes residual hydrogen and increased moisture content from the reaction of oxygen and hydrogen in the fuel cell stack 212, leaves the fuel cell stack 212 via the cathode air exhaust outlet 346. After passing through the humidifier 304 to remove excess moisture, the exhaust air is routed to the combustor 324 where the residual hydrogen in the exhaust air is combined with oxygen to create water and generate heat, which results in an increase in the pressure of the air leaving the combustor 324.

The turbine 308 is driven by the pressure differential between the air leaving the combustor 324 and the combined exhaust 342, which is at ambient pressure. The turbine 308 assists the motor 332 in driving the compressor 306, which compresses the inlet air as discussed above. The turbine 308 thus decreases the amount of work done by the motor 332 in compressing the inlet air, increasing the overall efficiency of the energy supply system 200.

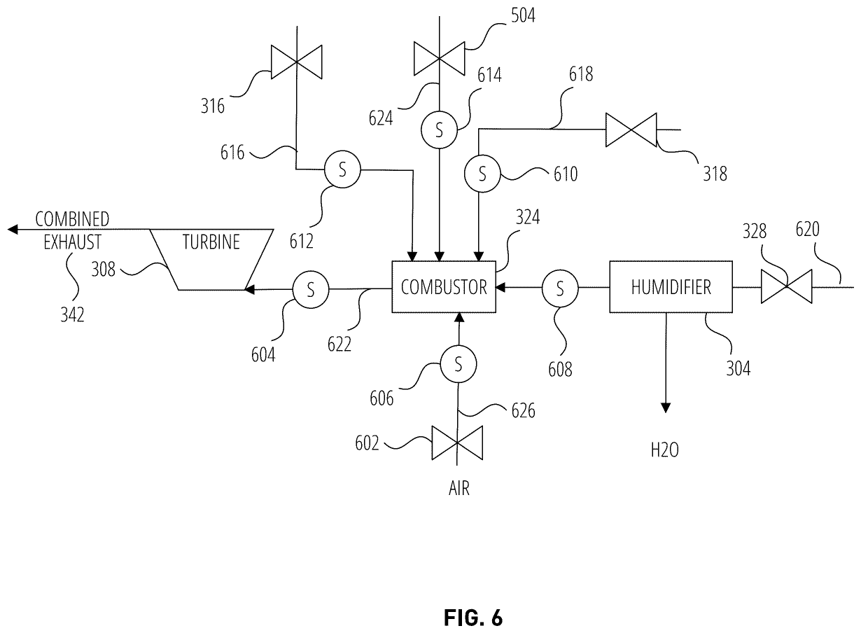

The combustor 324 can take various forms. In some examples, the combustor 324 is a hydrogen to water catalytic converter, which generates water from hydrogen at a lower temperature than combusting the hydrogen directly. The materials and chemistry of hydrogen to water catalytic conversion is well known, since this is a reaction that also takes place in the fuel cell stack 212. In some examples the catalyst in the combustor 324 is nickel, porous nickel or a nickel alloy. In other examples, the combustor 324 includes a standard combustion chamber in which the hydrogen is ignited is combusted by a spark ignitor, hot surface ignitor, pilot flame, or other ignition source. The combustor 324 in some examples receives additional air from the compressor 306 or intercooler 330 to provide supplementary oxygen for use by the combustor 324, as described in more detail below with reference to FIG. 6.

The turbine 308 can alternatively be any other type of expansion engine that can be used to convert the expansion of the gas from the combustor 324 into work, such as for example a piston engine. Similarly, the compressor 306 can alternatively be any other mechanical device that can extract work from operation of the expansion engine, such as a dynamo or generator.

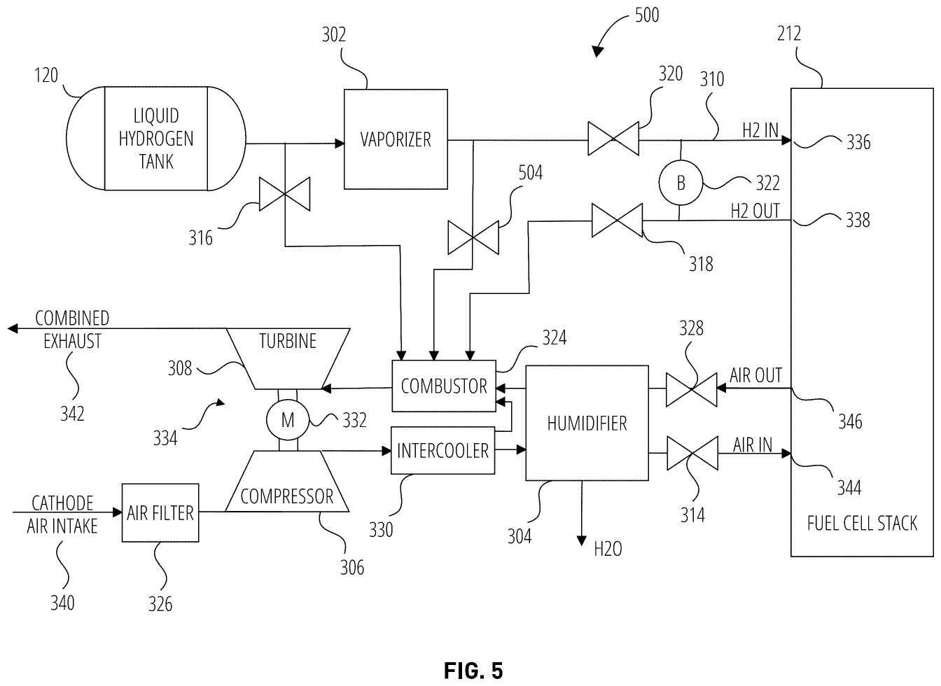

Although a single turbine and compressor 334 is illustrated in FIG. 5, in some examples multiple turbine and compressors 334 are provided to compress the input air in two or more stages. For example, a mid-pressure turbine and compressor combination can provide intermediate compression of input air, which is then compressed further by a high-pressure turbine and compressor combination before provision to a fuel cell stack 212.

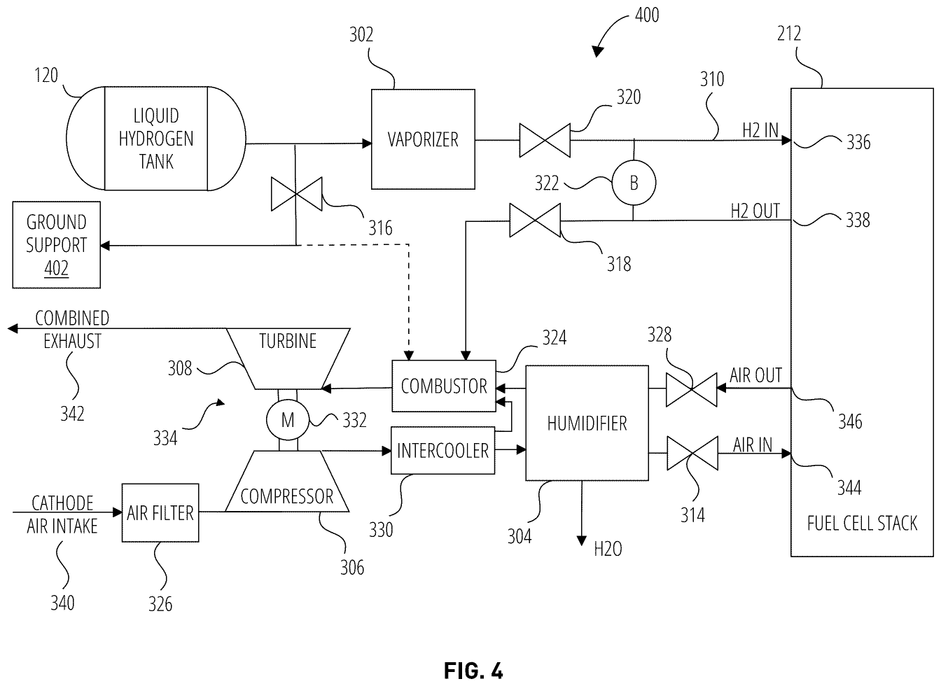

FIG. 4 is a schematic diagram illustrating a hydrogen and air supply system 400 for use in the aircraft 100, according to some examples. As before, the hydrogen supply system 202 comprises a liquid hydrogen tank 120, a vaporizer 302, a fuel cell stack 212 a humidifier 304 and a combined turbine and compressor 334. Unless stated otherwise, the functioning of these components is as described above with reference to FIG. 3.

Evaporation of hydrogen gas from the liquid hydrogen in the liquid hydrogen tank 120 and the associated need to purge this evaporated hydrogen from a purge valve 316 may not occur during operation of the aircraft 100, due to consumption of the hydrogen by the fuel cell stack 212 and based on the design of the liquid hydrogen tank 120. However, while the aircraft 100 is not in operation on the ground, liquid hydrogen in the tank will evaporate and require venting over time. This issue may prevent a hydrogen powered aircraft from being stored inside a hanger due to safety restrictions.

In such a case, the purge valve 316 is coupled to an umbilical cord connected to a ground support energy recovery system 402, which recovers or consumes the vented hydrogen. In some examples the ground support energy recovery system 402 comprises a small fuel cell for the generation of electricity, a hydrogen liquefier to condense the hydrogen for reuse, or a combustor like the combustor 324 for converting the excess hydrogen to water. In the latter case, a small turbine and generator is be provided for electricity generation in some examples.

In some examples, the purge valve 316 is a three-way valve that can be switched between the ground support energy recovery system 402 and the purge valve 316 to permit excess hydrogen to be recovered or used, in both an operative and inoperative modes of the hydrogen and air supply system 400 as described with reference to FIG. 3 and FIG. 4 respectively.

FIG. 5 is a schematic diagram illustrating a hydrogen and air supply system 500 for use in the aircraft 100, according to some examples. As before, the hydrogen supply system 202 comprises a liquid hydrogen tank 120, a vaporizer 302, a fuel cell stack 212 a humidifier 304 and a combined turbine and compressor 334. Unless stated otherwise, the functioning of these components is as described above with reference to FIG. 3.

While the functioning of the hydrogen and air hydrogen supply systems 300, 400 provide increases in efficiency to the energy supply system 200 due to the assistance to the compressor 306 provided by the combustor 324 and turbine 308, in some examples it may be beneficial to boost the power output of the energy supply system 200 on demand. If the net output of the energy supply system 200 is 125 KW, the compressor(s) used to provide air to the fuel cell stacks 212 may consume 15-25 KW of the gross power output as a parasitic loss. If this loss can temporarily be eliminated or significantly reduced, the net power output of the energy supply system 200 can be increased by up to 150 KW for example. The extra power can be used for takeoff or climbing, or in the case of an emergency.

To provide such an on-demand power boost, the hydrogen and air supply system 500 includes a controllable valve 504 that couples the hydrogen supply line 310 downstream of the vaporizer 302 directly to the combustor 324. The valve 504 is selectively operable by the energy supply management system 214, for example in response to pilot or autonomous control inputs, to provide hydrogen directly to the combustor 324. This additional hydrogen is then combusted by the combustor to provide additional expansion of the air provided to the turbine and compressor 334. If required, additional oxygen is supplied as described below with reference to FIG. 6.

Although this use of hydrogen will be less efficient than its consumption by the fuel cell 204, in certain circumstances it can be justified and beneficial to provide a greater power output capability of the fuel cell 204 without significantly affecting the mass of the energy supply system 200.

FIG. 6 is a schematic diagram illustrating the connections to the combustor 324 of FIG. 3 in more detail. As discussed above, the combustor 324 receives excess or residual hydrogen from one or more of the liquid hydrogen tank 120 from hydrogen purge line 616 via purge valve 316, from the hydrogen outlet 338 of the fuel cell stack 212 from circulation loop purge line 618 via purge valve 318, from the cathode air exhaust outlet 346 from cathode air exhaust line 620 via the valve 328, or from the liquid hydrogen tank 120 from hydrogen supply line 624 via valve 602. The air leaving the combustor 324 is provided to the turbine 308 via combustor exhaust line 622.

The amount of hydrogen received by the combustor 324 and the presence and amount of oxygen accompanying the hydrogen received by the combustor 324 will vary. Depending on the circumstances, it may be necessary to provide oxygen to the combustor 324, or to supplement the existing oxygen being received along with the excess or residual hydrogen, to permit the required combustion of the excess or residual hydrogen. Additional oxygen is supplied in air provided from supplementary air line 626 via valve 602. Supplementary air line 626 can be coupled to the cathode air intake supply line 312 upstream or downstream of the intercooler 330, or the supplementary air line 626 may separately be supplied with ambient air, suitably pressurized and valved.

For example, during operation of the fuel cell stack 212, a flow of exhaust that contains residual hydrogen and oxygen will be received constantly by the combustor 324 from the humidifier 304. However, pure hydrogen will only be received intermittently from the purge valve 316, when the pressure of the evaporated hydrogen reaches the predetermined purge level. Hydrogen, nitrogen and water vapor will only be received intermittently from the purge valve 318 when it is necessary to purge the circulation loop that includes the blower 322, hydrogen outlet 338 and hydrogen inlet 336 of excess nitrogen and water. Finally, hydrogen will be received intermittently on demand from the valve 504 in response to pilot or autonomous control inputs, to provide hydrogen directly to the combustor 324.

The concentration and relative percentages of hydrogen and oxygen received by the combustor 324 will thus vary depending on the circumstances. To ensure an appropriate ratio of hydrogen to oxygen, one or more sensors 604, 606, 608, 610, 612 and 614 are provided in combustor exhaust line 622, supplementary air line 626, cathode air exhaust line 620, circulation loop purge line 618 and hydrogen purge line 616 respectively. In some examples, the sensors include mass flowrate sensors and/or oxygen sensors. The outputs of the sensors are coupled to the energy supply management system 214, which, based on the sensor outputs, opens or closes the valve 602 in the supplementary air line 626 by degrees, to maintain sufficient oxygen in the combustor 324 to combust the hydrogen received from one or more of the hydrogen purge line 616, circulation loop purge line 618 and cathode air exhaust line 620.

In some examples, sensor 604, which may be upstream or downstream of turbine 308, includes an oxygen sensor to measure residual oxygen in the combustor exhaust line 622. If the level of residual oxygen in the combustor exhaust line 622 falls below a certain predetermined level, the energy supply management system 214 opens the valve 602 by degrees to admit supplementary air, containing oxygen, to the combustor 324 to maintain the residual oxygen in the combustor exhaust line 622 above the predetermined level. The amount by which the valve 602 is opened, and thus the amount of supplementary air provided to the combustor is thus controlled by the energy supply management system 214 in an inverse relationship to the level of oxygen in the combustor exhaust line 622.

Additional sensors or data may be utilized. For example, detection of the opening of the purge valve 316 or detection of flow by the sensor 612 can trigger an immediate increase in the supply of additional oxygen by the valve 602. Similarly, a command to open the purge valve 318 to purge the hydrogen circulation loop, or detection of opening of the purge valve 318, can similarly trigger an immediate increase in the supply of additional oxygen by the valve 602.

In further examples a hydrogen concentration sensor could be provided downstream of the combustor 324. Based on the hydrogen concentration sensor registering more than a threshold amount of hydrogen leaving the combustor, the energy supply management system 214 opens the valve 602 by degrees to admit supplementary air, containing oxygen, to the combustor 324 to maintain the residual hydrogen in the combustor exhaust line 622 below the predetermined threshold level. The amount by which the valve 602 is opened, and thus the amount of supplementary air provided to the combustor is thus controlled by the energy supply management system 214 in a direct relationship to the level of hydrogen in the combustor exhaust line 622.

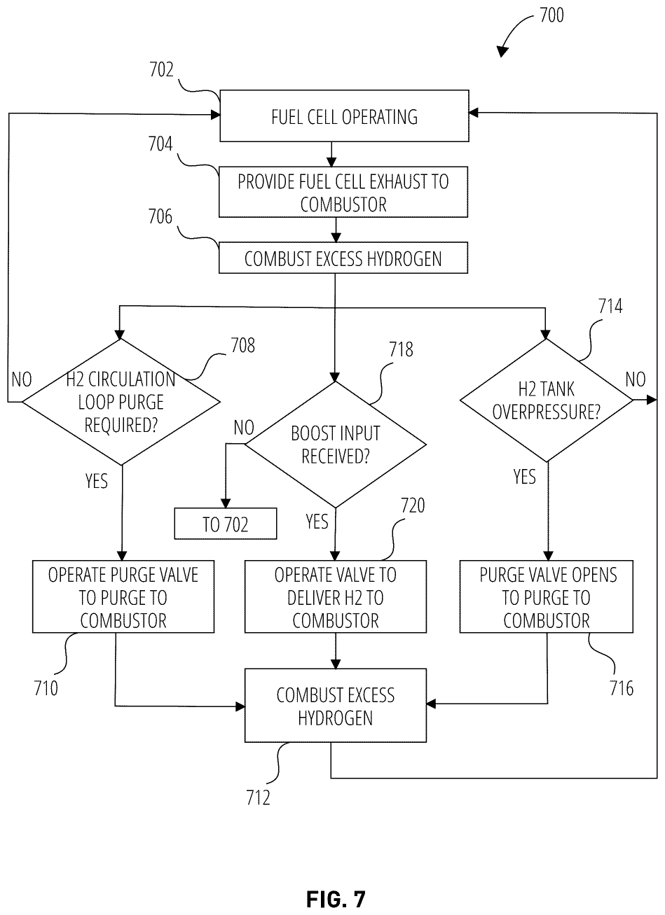

FIG. 7 is a flowchart 700 illustrating operation of the energy supply system 200 according to some examples. For explanatory purposes, the operations of the flowcharts 700 and 800 are described herein as occurring in serial, or linearly. However, multiple operations of the flowcharts may occur in parallel. In addition, the operations of the flowcharts need not be performed in the order shown and/or one or more blocks of the flowcharts need not be performed and/or can be replaced by other operations. The operations of the flowcharts may be performed by various components of the energy supply system 200 under control of the energy supply management system 214, or by related systems and processors.

The flowchart 700 commences at operation 702, in which the fuel cell is operating as described above with reference to FIG. 3. In operation 704, the air supply system 206 provides the fuel cell exhaust to the combustor 324 from the cathode air exhaust outlet 346 via valve 328 and humidifier 304. The combustor 324 then combusts the excess hydrogen in the fuel cell exhaust in operation 706.

While this is ongoing, the energy supply system 200 checks if the hydrogen circulation loop needs purging in operation 708. This depends on the level of nitrogen and water present in the hydrogen circulation loop. If the level of nitrogen or water in the hydrogen circulation loop exceeds a predetermined level, the energy supply system 200 operates the purge valve 318 in operation 710 to supply the purge gas mixture to the combustor 324 via the circulation loop purge line 618. The combustor 324 then combusts the excess hydrogen in the fuel cell exhaust in operation 712. If the hydrogen supply loop does not need purging as determined in operation 708, the method returns to operation 702 and continues from there.

Similarly, while this is ongoing, if there is overpressure in the liquid hydrogen tank 120 as set forth in operation 714, then the purge valve 316 will open, to supply the excess hydrogen from the liquid hydrogen tank 120 to the combustor 324 via the hydrogen purge line 616 in operation 716. The combustor 324 then combusts the excess hydrogen from the liquid hydrogen tank 120 in operation 712. If there is no purging of hydrogen from the liquid hydrogen tank 120, as set forth in operations 714 and 716, then the method returns to operation 702 and continues from there. The opening of the purge valve 316 in operation 716 occurs automatically for safety reasons, and is typically not based on a command from the energy supply system 200. In some examples however, the purge valve 316 is opened by the energy supply management system 214 based on a pressure value detected by a pressure sensor in or in-line with the hydrogen tank exceeding a predetermined pressure level.

Still further, while the combustion of excess hydrogen is continuing in operation 706, upon receipt of a command to provide a power boost in operation 718, as described above with reference to FIG. 5 and FIG. 6, the energy supply management system 214 will open the valve 504 to supply hydrogen from the liquid hydrogen tank 120 to the combustor 324 in operation 720. The combustor 324 then combusts the additional hydrogen received from the liquid hydrogen tank 120 in operation 712. If no command is received in operation 718, the method returns to operation 702 and continues from there.

The higher pressure combusted gas output from the combustor 324 is supplied to the turbine 308, where it expands and drives the turbine 308 to provide mechanical assistance to the compressor 306 and motor 332. In some examples, the compressor 306 and motor 332 are replaced by a generator or alternator to generate electrical power.

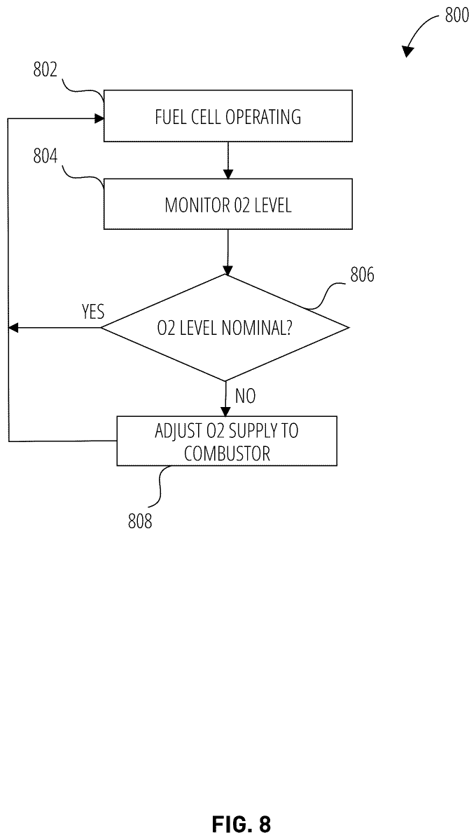

FIG. 8 is a flowchart 800 illustrating further operation of the energy supply system 200 according to some examples. The operations of flowchart 800 occur in parallel with the operations of the flowchart 700 The flowchart 800 commences at operation 702, in which the fuel cell is operating as described above with reference to FIG. 3. At this time, the combustor 324 is being supplied with excess hydrogen from one or more of the cathode air exhaust line 620, the hydrogen purge line 616, the circulation loop purge line 618 and the hydrogen supply line 624 as described above with reference to FIG. 7.

In operation 804, the level of oxygen in one or more of the combustor exhaust line 622, the cathode air exhaust line 620 and the circulation loop purge line 618 is monitored by the energy supply system 200 using one or more of the sensors 604, 608 and 610 respectively. If the oxygen level(s) are nominal as determined in operation 806, then the method returns to operation 802 and proceeds from there. If the oxygen level is not nominal as determined in operation 806, the oxygen supply to the combustor 324 is adjusted in operation 808. This is done for example by the energy supply system 200 adjusting the degree of opening of the valve 602 in the supplementary air line 626 to adjust the amount of additional oxygen supplied to the combustor 324. If the oxygen level as determined in operation 804 is greater than required, then the degree of opening of the valve 602 will be reduced. Similarly, if the oxygen level as determined in operation 804 is less than required, then the degree of opening of the valve 602 will be increased to provide more oxygen.

The methods of operation in flowchart 700 and flowchart 800 will continue in operation of the fuel cell stack 212 and hydrogen supply system. If the aircraft 100 is stationary on the ground and powered off, the hydrogen purge line 616 is coupled to the ground support energy recovery system 402, which will receive and handle any excess hydrogen vented from the liquid hydrogen tank 120 as discussed above with reference to FIG. 4

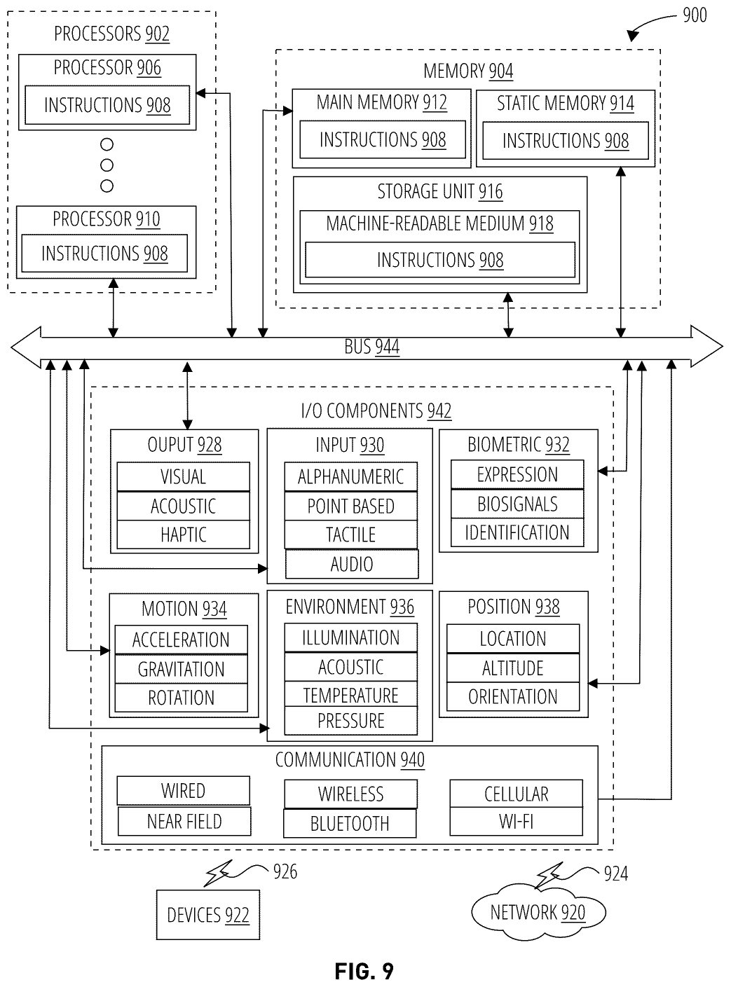

FIG. 9 illustrates a diagrammatic representation of a machine 900 in the form of a computer system within which a set of instructions may be executed for causing the machine to perform any one or more of the methodologies discussed herein, such as the energy supply management system 214 according to some examples. Specifically, FIG. 9 shows a diagrammatic representation of the machine 900 in the example form of a computer system, within which instructions 908 (e.g., software, a program, an application, an applet, an app, or other executable code) for causing the machine 900 to perform any one or more of the methodologies discussed herein may be executed. The instructions 908 transform the general, non-programmed machine 900 into a particular machine 900 programmed to carry out the described and illustrated functions in the manner described. In alternative examples, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 908, sequentially or otherwise, that specify actions to be taken by the machine 900. Further, while only a single machine 900 is illustrated, the term “machine” shall also be taken to include a collection of machines 900 that individually or jointly execute the instructions 908 to perform any one or more of the methodologies discussed herein.

The machine 900 may include processors 902, memory 904, and I/O components 942, which may be configured to communicate with each other such as via a bus 944. In an example, the processors 902 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 906 and a processor 910 that may execute the instructions 908. The term “processor” is intended to include multi-core processors that may comprise two or more independent processors (sometimes referred to as “cores”) that may execute instructions contemporaneously. Although FIG. 9 shows multiple processors 902, the machine 900 may include a single processor with a single core, a single processor with multiple cores (e.g., a multi-core processor), multiple processors with a single core, multiple processors with multiples cores, or any combination thereof.

The memory 904 may include a main memory 912, a static memory 914, and a storage unit 916, both accessible to the processors 902 such as via the bus 944. The main memory 904, the static memory 914, and storage unit 916 store the instructions 908 embodying any one or more of the methodologies or functions described herein. The instructions 908 may also reside, completely or partially, within the main memory 912, within the static memory 914, within machine-readable medium 918 within the storage unit 916, within at least one of the processors 902 (e.g., within the processor's cache memory), or any suitable combination thereof, during execution thereof by the machine 900.

The I/O components 942 may include a wide variety of components to receive input, provide output, produce output, transmit information, exchange information, capture measurements, and so on. The specific I/O components 942 that are included in a particular machine will depend on the type of machine. For example, portable machines such as mobile phones will likely include a touch input device or other such input mechanisms, while a headless server machine will likely not include such a touch input device. It will be appreciated that the I/O components 942 may include many other components that are not shown in FIG. 9. The I/O components 942 are grouped according to functionality merely for simplifying the following discussion and the grouping is in no way limiting. In various examples, the I/O components 942 may include output components 928 and input components 930. The output components 928 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 930 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 942 may include biometric components 932, motion components 934, environmental components 936, or position components 938, among a wide array of other components. For example, the biometric components 932 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 934 may include acceleration sensor components (e.g., accelerometer), gravitation sensor components, rotation sensor components (e.g., gyroscope), and so forth. The environmental components 936 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 938 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 942 may include communication components 940 operable to couple the machine 900 to a network 920 or devices 922 via a coupling 924 and a coupling 926, respectively. For example, the communication components 940 may include a network interface component or another suitable device to interface with the network 920. In further examples, the communication components 940 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 922 may be another machine or any of a wide variety of peripheral devices (e.g., a peripheral device coupled via a USB).

Moreover, the communication components 940 may detect identifiers or include components operable to detect identifiers. For example, the communication components 940 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 940, such as location via Internet Protocol (IP) geolocation, location via Wi-Fi® signal triangulation, location via detecting an NFC beacon signal that may indicate a particular location, and so forth.

### EXECUTABLE INSTRUCTIONS AND MACHINE STORAGE MEDIUM

The various memories (i.e., memory 904, main memory 912, static memory 914, and/or memory of the processors 902) and/or storage unit 916 may store one or more sets of instructions and data structures (e.g., software) embodying or utilized by any one or more of the methodologies or functions described herein. These instructions (e.g., the instructions 908), when executed by processors 902, cause various operations to implement the disclosed examples.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### TRANSMISSION MEDIUM

In various examples, one or more portions of the network 920 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 920 or a portion of the network 920 may include a wireless or cellular network, and the coupling 924 may be a Code Division Multiple Access (CDMA) connection, a Global System for Mobile communications (GSM) connection, or another type of cellular or wireless coupling. In this example, the coupling 924 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 908 may be transmitted or received over the network 920 using a transmission medium via a network interface device (e.g., a network interface component included in the communication components 940) and utilizing any one of a number of well-known transfer protocols (e.g., hypertext transfer protocol (HTTP)). Similarly, the instructions 908 may be transmitted or received using a transmission medium via the coupling 926 (e.g., a peer-to-peer coupling) to the devices 922. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 908 for execution by the machine 900, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### COMPUTER-READABLE MEDIUM

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

Various examples are contemplated. Example 1 is a system for use with a fuel cell stack supplied by a tank of hydrogen, comprising: an exhaust line to receive exhaust gas from the fuel cell stack, the exhaust gas including hydrogen gas; a combustor coupled to the exhaust line to receive and combust the hydrogen gas in the exhaust gas; an expansion engine coupled to the combustor to receive combusted exhaust from the combustor; and a mechanical device coupled to the expansion engine to extract work from operation of the expansion engine.

In Example 2, the subject matter of Example 1 includes, an oxygen sensor located downstream of the combustor to determine an oxygen level in combusted gas from the combustor; and a control system to supply supplementary oxygen to the combustor based on the oxygen level detected by the oxygen sensor.

In Example 3, the subject matter of Examples 1-2 includes, wherein the combustor is further coupled to the tank of hydrogen by a valve selectively operable to supply hydrogen on demand to the combustor from the tank of hydrogen.

In Example 4, the subject matter of Examples 1-3 includes, wherein the combustor is further coupled to a hydrogen circulation loop of the fuel cell stack to receive circulation-loop purge gas containing hydrogen, the combustor in use combusting the hydrogen contained in the circulation-loop purge gas.

In Example 5, the subject matter of Example 4 includes, wherein the combustor is further coupled to a hydrogen purge line of the tank of hydrogen, the combustor in use combusting hydrogen received from the tank of hydrogen via the hydrogen purge line.

In Example 6, the subject matter of Examples 4-5 includes, an oxygen sensor located downstream of the combustor to determine an oxygen level in combusted gas from the combustor; and a control system to supply supplementary oxygen to the combustor based on the oxygen level detected by the oxygen sensor.

In Example 7, the subject matter of Example 6 includes, wherein the mechanical device comprises a fuel cell input-air compressor and the combustor receives supplementary oxygen from the fuel cell input-air compressor under control of the control system.

In Example 8, the subject matter of Examples 1-7 includes, wherein the combustor is further coupled to a hydrogen purge line of the tank of hydrogen, the combustor in use combusting hydrogen received from the tank of hydrogen via the hydrogen purge line.

In Example 9, the subject matter of Example 8 includes, an oxygen sensor located downstream of the combustor to determine an oxygen level in combusted gas from the combustor; and a control system to supply supplementary oxygen to the combustor based on the oxygen level detected by the oxygen sensor.

In Example 10, the subject matter of Example 9 includes, wherein the mechanical device comprises a fuel cell input-air compressor and the combustor receives supplementary oxygen from the fuel cell input-air compressor under control of the control system.

In Example 11, the subject matter of Examples 1-10 includes, a hydrogen sensor located downstream of the combustor to determine a hydrogen level in combusted gas from the combustor; and a control system to supply supplementary oxygen to the combustor based on the hydrogen level detected by the hydrogen sensor.

In Example 12, the subject matter of Examples 1-11 includes, wherein the mechanical device comprises a fuel cell input-air compressor.

In Example 13, the subject matter of Example 12 includes, wherein the expansion engine comprises a turbine coupled to the fuel cell input-air compressor.

Example 14 is a method or operating a system including a fuel cell stack supplied by a tank of hydrogen, comprising: receiving exhaust gas from the fuel cell stack, the exhaust gas including hydrogen gas; combusting the hydrogen gas in the exhaust gas to generate combusted exhaust gas; and expanding the combusted exhaust gas to extract work therefrom.

In Example 15, the subject matter of Example 14 includes, wherein the system includes a fuel cell a hydrogen circulation loop for the fuel cell stack, the method further comprising: receiving circulation-loop purge gas containing hydrogen; and combusting the hydrogen contained in the circulation-loop purge gas with the hydrogen in the exhaust gas.

In Example 16, the subject matter of Examples 14-15 includes, receiving hydrogen from the tank of hydrogen; and combusting the hydrogen received from the tank of hydrogen with the hydrogen in the exhaust gas.

In Example 17, the subject matter of Examples 14-16 includes, detecting a level of the hydrogen gas in the combusted exhaust gas; and supplying supplementary oxygen for the combustion of the hydrogen gas based on the detected level of the hydrogen gas.

In Example 18, the subject matter of Examples 14-17 includes, detecting a level of oxygen in the combusted exhaust gas; and supplying supplementary oxygen for the combustion of the hydrogen gas based on the detected oxygen level.

Example 19 is a non-transitory machine-readable medium including instructions which, when read by a machine, cause the machine to perform operations in a system including a fuel cell stack supplied by a tank of hydrogen, the operations comprising: receiving exhaust gas from the fuel cell stack, the exhaust gas including hydrogen gas; combusting the hydrogen gas in the exhaust gas to generate combusted exhaust gas; and expanding the combusted exhaust gas to extract work therefrom.

In Example 20, the subject matter of Example 19 includes, wherein the system includes a fuel cell a hydrogen circulation loop for the fuel cell stack, the operations further comprising: receiving circulation-loop purge gas containing hydrogen; and combusting the hydrogen contained in the circulation-loop purge gas with the hydrogen in the exhaust gas.

Example 21 is at least one machine-readable medium including instructions that, when executed by processing circuitry, cause the processing circuitry to perform operations to implement of any of Examples 1-20. Example 22 is an apparatus comprising means to implement of any of Examples 1-20. Example 23 is a system to implement of any of Examples 1-20. Example 24 is a method to implement of any of Examples 1-20.

Examples of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the examples of the invention disclosed herein without departing from the scope of this invention defined in the following claims.

What is claimed is:

1. A system for use with a fuel cell stack supplied by a tank of hydrogen, comprising:
an exhaust line to receive exhaust gas from the fuel cell stack, the exhaust gas including hydrogen gas;
a combustor coupled to the exhaust line to receive and combust the hydrogen gas in the exhaust gas;
an expansion engine coupled to the combustor to receive combusted exhaust from the combustor; and
a mechanical device coupled to the expansion engine to extract work from operation of the expansion engine.

2. The system of claim 1, further comprising:
an oxygen sensor located downstream of the combustor to determine an oxygen level in combusted gas from the combustor; and
a control system to supply supplementary oxygen to the combustor based on the oxygen level detected by the oxygen sensor.

3. The system of claim 1, wherein the combustor is further coupled to the tank of hydrogen by a valve selectively operable to supply hydrogen on demand to the combustor from the tank of hydrogen.

4. The system of claim 1, wherein the combustor is further coupled to a hydrogen circulation loop of the fuel cell stack to receive circulation-loop purge gas containing hydrogen, the combustor in use combusting the hydrogen contained in the circulation-loop purge gas.

5. The system of claim 4, wherein the combustor is further coupled to a hydrogen purge line of the tank of hydrogen, the combustor in use combusting hydrogen received from the tank of hydrogen via the hydrogen purge line.

6. The system of claim 4, further comprising:
an oxygen sensor located downstream of the combustor to determine an oxygen level in combusted gas from the combustor; and
a control system to supply supplementary oxygen to the combustor based on the oxygen level detected by the oxygen sensor.

7. The system of claim 6, wherein the mechanical device comprises a fuel cell input-air compressor and the combustor receives supplementary oxygen from the fuel cell input-air compressor under control of the control system.

8. The system of claim 1, wherein the combustor is further coupled to a hydrogen purge line of the tank of hydrogen, the combustor in use combusting hydrogen received from the tank of hydrogen via the hydrogen purge line.

9. The system of claim 8, further comprising:
an oxygen sensor located downstream of the combustor to determine an oxygen level in combusted gas from the combustor; and
a control system to supply supplementary oxygen to the combustor based on the oxygen level detected by the oxygen sensor.

10. The system of claim 9, wherein the mechanical device comprises a fuel cell input-air compressor and the combustor receives supplementary oxygen from the fuel cell input-air compressor under control of the control system.

11. The system of claim 1, further comprising:
a hydrogen sensor located downstream of the combustor to determine a hydrogen level in combusted gas from the combustor; and
a control system to supply supplementary oxygen to the combustor based on the hydrogen level detected by the hydrogen sensor.

12. The system of any one of claim 1 wherein the mechanical device comprises a fuel cell input-air compressor.

13. The system of claim 12 wherein the expansion engine comprises a turbine coupled to the fuel cell input-air compressor.

14. A method or operating a system including a fuel cell stack supplied by a tank of hydrogen, comprising:
receiving exhaust gas from the fuel cell stack, the exhaust gas including hydrogen gas;
combusting the hydrogen gas in the exhaust gas to generate combusted exhaust gas; and
expanding the combusted exhaust gas to extract work therefrom.

15. The method of claim 14, wherein the system includes a fuel cell a hydrogen circulation loop for the fuel cell stack, the method further comprising:
receiving circulation-loop purge gas containing hydrogen; and
combusting the hydrogen contained in the circulation-loop purge gas with the hydrogen in the exhaust gas.

16. The method of claim 14, further comprising:
receiving hydrogen from the tank of hydrogen; and
combusting the hydrogen received from the tank of hydrogen with the hydrogen in the exhaust gas.

17. The method of claim 14, further comprising:
detecting a level of the hydrogen gas in the combusted exhaust gas; and
supplying supplementary oxygen for the combustion of the hydrogen gas based on the detected level of the hydrogen gas.

18. The method of claim 14,
detecting a level of oxygen in the combusted exhaust gas; and
supplying supplementary oxygen for the combustion of the hydrogen gas based on the detected oxygen level.

19. A non-transitory machine-readable medium including instructions which, when read by a machine, cause the machine to perform operations in a system including a fuel cell stack supplied by a tank of hydrogen, the operations comprising:
receiving exhaust gas from the fuel cell stack, the exhaust gas including hydrogen gas;
combusting the hydrogen gas in the exhaust gas to generate combusted exhaust gas; and
expanding the combusted exhaust gas to extract work therefrom.

20. The non-transitory machine-readable medium of claim 19, wherein the system includes a fuel cell a hydrogen circulation loop for the fuel cell stack, the operations further comprising:
receiving circulation-loop purge gas containing hydrogen; and
combusting the hydrogen contained in the circulation-loop purge gas with the hydrogen in the exhaust gas.
